(19) United States
(12) Patent Application Publication
(10) Pub. No.: US 2016/0090956 A1
(43) Pub. Date: Mar. 31, 2016

(54) DIESEL FUEL PUMP

(71) Applicant: KOGANEI SEIKI CO., LTD., lruma-shi (JP)

(72) Inventor: Masaharu TSUBOI, Sayama-shi (JP)

(73) Assignee: KOGANEI SEIKI CO., LTD., lruma-shi (JP)

(21) Appl. No.: 14/863,596

(22) Filed: Sep. 24, 2015

(30) Foreign Application Priority Data
Sep. 26, 2014 (JP) 2014-196938

(51) Int. Cl. F02M 59/46; F04B 53/10; F02M 59/02

(52) U.S. Cl. CPC F02M 59/464; F02M 59/025; F04B 53/1002

(57) ABSTRACT

A diesel fuel pump includes a cylinder provided to a housing, and a plunger configured to form a cylinder chamber in conjunction with the cylinder by being reciprocably provided to the cylinder. The plunger compresses fuel inside the cylinder chamber when the plunger moves in one direction during a reciprocating motion, and introduces the fuel into the cylinder chamber when the plunger moves in another direction. A ball-type non-return valve includes: a spherical ball; a valve seat having a through-hole provided with a truncated side surface-shaped inner surface; and a compression coil spring provided inside the cylinder chamber, and having one end portion in contact with the ball and another end portion in contact with the cylinder. A value of a winding diameter of the compression coil spring is reduced at the one end portion.

### BACKGROUND OF THE INVENTION

1. Field of the Invention

The present invention relates to a diesel fuel pump configured to supply fuel to a diesel engine.

2. Description of Related Art

A diesel fuel pump 301 as shown in FIG. 1 has heretofore been known (Japanese Utility Model Registration No. 3154559).

The diesel fuel pump 301 includes a housing 303, a drive shaft 307 provided with a rider shaft (a driver of a disc cam) 305, a rider 309, a plunger 311, and a cylinder 315 which forms a cylinder chamber 313 in conjunction with the plunger 311.

The drive shaft 307 is supported by bearings 317 and 319, and is thus made rotatable relative to the housing 303. Meanwhile, the rider 309 is supported by the rider shaft 305 via multiple needle rollers 321, and is thus made rotatable relative to the rider shaft 305.

In the plunger 311, a planar portion 323 formed at one end portion thereof is biased toward a planar portion 325 formed at a portion on the outer periphery of the rider 309 by a biasing force of a compression coil spring 327. Thus, the planar portion 323 and the planar portion 325 come into surface contact with each other. Meanwhile, an intermediate portion of the plunger 311 is engaged with the cylinder 315. Hence, the plunger 311 is configured such that by rotation of the drive shaft 307, the plunger 311 reciprocates with respect to the cylinder 315 which is integrated with the housing 303.

In the meantime, the housing 303 is provided with a non-return valve 329 where fuel to be introduced into the cylinder chamber 313 passes through, and another non-return valve (not shown in FIG. 1) where the fuel to be ejected from the cylinder chamber 313 (the compressed fuel) passes through.

Moreover, the volume of the cylinder chamber 313 changes with a reciprocating motion of the plunger 311, whereby the fuel is introduced into the cylinder chamber 313, then the fuel introduced into the cylinder chamber 313 is compressed, and the compressed fuel is ejected from the cylinder chamber 313. The ejected fuel passes through a fuel injector (not shown) and is injected into a cylinder chamber of a diesel engine.

### SUMMARY OF THE INVENTION

In the meantime, a valve body 331 of a non-return valve 329 of the conventional diesel fuel pump 301 is partially provided with a truncated cone-shaped region 333. The truncated cone-shaped region 333 is biased by a biasing force generated by a compression coil spring 339 and comes into contact with a truncated cone-shaped recess 337 provided to a valve seat 335. Thus, the region 333 and the recess 337 play a role as the non-return valve.

Accordingly, the conventional diesel fuel pump 301 requires accurate processing of the truncated cone-shaped region 333 of the valve body 331 and the truncated cone-shaped recess 337 provided to the valve seat 335, which leads to a problem of an increase in manufacturing cost.

An object of the present invention is to provide a diesel fuel pump which can suppress a manufacturing cost for a non-return valve.

A first aspect of the present invention provides a diesel fuel pump which includes: a cylinder provided to a housing; a plunger configured to form a cylinder chamber in conjunction with the cylinder by being reciprocably provided to the cylinder, to compress fuel inside the cylinder chamber when the plunger moves in a first direction during a reciprocating motion, and to introduce the fuel into the cylinder chamber when the plunger moves in a second direction during the reciprocating motion; and a ball-type non-return valve including a spherical ball, a valve seat having a through-hole provided with a truncated side surface-shaped inner surface, and a compression coil spring provided inside the cylinder chamber, having a first end portion in contact with the ball and a second end portion in contact with the cylinder, with a value of a winding diameter reduced at the first end portion. When the fuel is introduced into the cylinder chamber, the compression coil spring is compressed so as to open the through-hole in the valve seat and to allow passage of the fuel therethrough.

A portion of the compression coil spring to receive the ball may have a reduced winding radius.

The cylinder may include a through-hole where the plunger enters. The through-hole may include a first region provided at a third end portion, a second region provided at a fourth end portion, and a third region formed between the first region and the second region. The compression coil spring may be configured to enter and come into engagement with the first region. An inside diameter of the second region may be made smaller than an inside diameter of the first region. The plunger may be in engagement with the second region for the reciprocating motion. Moreover, an inside diameter of the third region may be made smaller than the inside diameter of the first region and slightly larger than an inside diameter of the second region.

A step may be formed on an outer periphery of the cylinder, and an outside diameter of a region closer to the third end portion than the step may be made larger than an outside diameter of a region close to the fourth end portion than the step. The cylinder may be installed in the housing by bringing the region closer to the third end portion than the step into engagement with the housing. Moreover, a boundary between the second region and the third region may be provided closer to the drive shaft than the step in light of an extending direction of a center axis of the cylinder.

### BRIEF DESCRIPTION OF THE DRAWINGS

FIG. 1 is a cross-sectional view of a conventional diesel fuel pump.

FIG. 2 is a cross-sectional view of a diesel fuel pump according to an embodiment of the present invention.

FIG. 3 is a view taken along line L3-L3 in FIG. 2

FIG. 4 is a view taken along line L4-L4 in FIG. 2

FIG. 5A is an enlarged view of part P5A in FIG. 2.

FIG. 5B is an enlarged view of part P5B in FIG. 5A.

FIG. 6 is an enlarged view of part P6 in FIG. 2.

FIG. 7 is a diagram showing a ball and a compression coil spring of a ball-type non-return valve provided to the diesel fuel pump according to the embodiment of the present invention.

FIG. 8A is a diagram showing a pump base of a trochoid pump provided to the diesel fuel pump according to the embodiment of the present invention.

FIG. 8B is a cross-sectional view taken along line L8B-L8B in FIG. 8A.

FIG. 9A is a diagram showing a rider of the diesel fuel pump according to the embodiment of the present invention.

FIG. 9B is a diagram viewed in the direction of arrow A9B in FIG. 9A.

FIG. 10A is a diagram showing an outer housing of the trochoid pump provided to the diesel fuel pump according to the embodiment of the present invention.

FIG. 10B is a cross-sectional view taken along line L10B-L1OB in FIG. 10A.

FIG. 11A is a diagram showing an inner housing of the trochoid pump provided to the diesel fuel pump according to the embodiment of the present invention.

FIG. 11B is a cross-sectional view taken along line L11B-L11B in FIG. 11A.

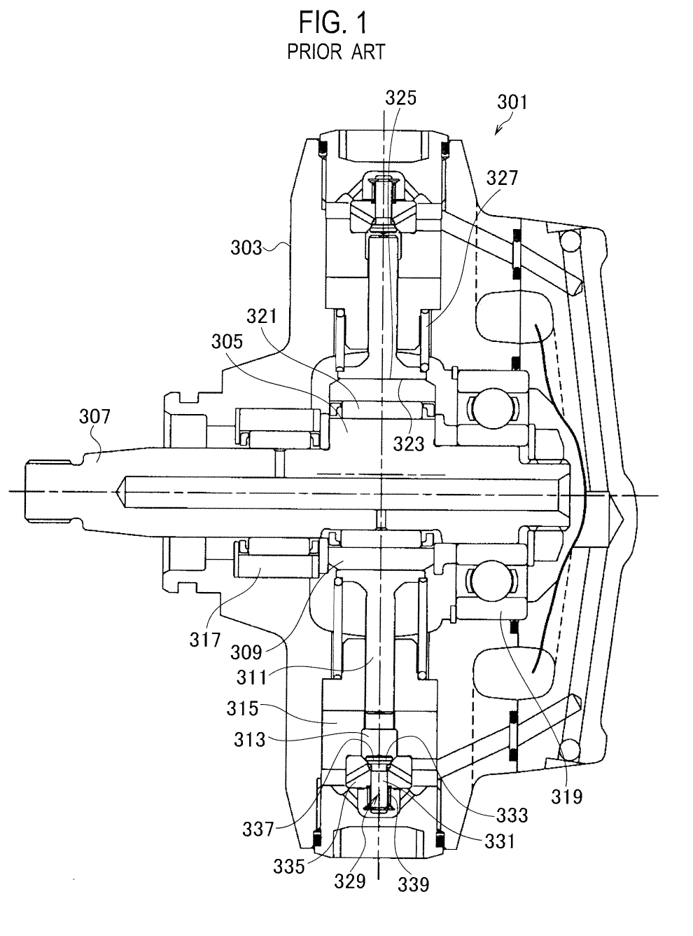

### DETAILED DESCRIPTION OF EMBODIMENT

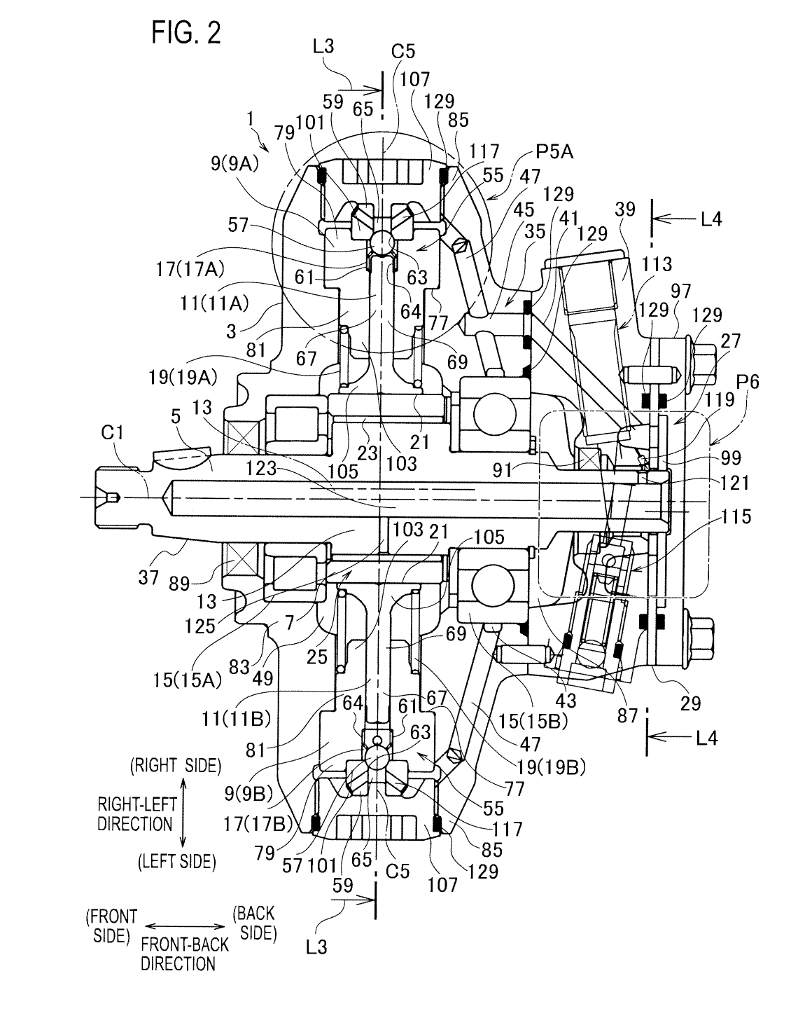

A diesel fuel pump (a fuel injection pump for a diesel engine) according to an embodiment of the present invention is configured to inject a high-pressure fuel into a cylinder of a diesel engine. As shown in FIG. 2 to FIG. 11B, a diesel fuel pump 1 includes a housing 3, a drive shaft 5, a rider 7, a first cylinder 9 (9A), a first plunger 11 (11A), a second cylinder 9 (9B), and a second plunger 11 (11B).

The drive shaft 5 includes a columnar rider shaft 13 serving as a driver of a disc cam (an eccentric). The drive shaft 5 is rotatably supported by the housing 3.

The center axis C3 of the columnar rider shaft 13 is parallel to the rotation center axis C1 of the drive shaft 5, and is located a predetermined distance away from the rotation center axis C1 of the drive shaft 5. In other words, the rider shaft 13 is eccentric with respect to the rotation center axis C1 of the drive shaft 5.

Moreover, the drive shaft 5 is provided inside the housing 3. The drive shaft 5 is supported by the housing 3 through a pair of rolling bearings 15 (15A, 15B) provided on one end side and another end side in an extending direction of the rotation center axis C1 (the right-left direction in FIG. 2). The rider shaft 13 is located between the pair of rolling bearings 15 (15A, 15B) in the extending direction of the rotation center axis C1 of the drive shaft 5.

The drive shaft 5 is rotationally driven relative to the housing 3 by a diesel engine (not shown) that employs the diesel fuel pump 1.

The rider 7 is formed into a cylindrical shape with its inside diameter equal to an outside diameter of the rider shaft 13. An inner peripheral surface of the rider 7 is engaged with an outer peripheral surface of the rider shaft 13 of the drive shaft 5. Thus, the rider 7 forms a sliding pair with and is made rotatable (capable of freely rotating) relative to the rider shaft 13.

Here, as shown in FIG. 2, the rider 7 may be supported by the rider shaft 13 through the rolling bearings and thus made to be capable of freely rotating relative to the rider shaft 13.

The center axis C3 of the rider shaft 13 and the center axis of the rider 7 coincide with each other, and the rider 7 is configured to rotate around (rotates on the axis of) the rider shaft 13 while using the center axis C3 of the rider shaft 13 as the rotation center. Meanwhile, since the center axis C3 of the rider shaft 13 is eccentric with respect to the rotation center axis C1 of the drive shaft 5, the rider 7 is configured to revolve about the rotation center axis C1 of the drive shaft 5.

The first cylinder (a first cylinder structural member) 9A is integrated with the housing 3.

The first plunger 11A is provided reciprocably (capable of freely reciprocating) to the first cylinder 9A. The first plunger 11A and the first cylinder 9A collectively form a first cylinder chamber (a first cylinder chamber configured to introduce fuel to the inside, to compress the fuel, and to eject the compressed fuel) 17 (17A).

Meanwhile, the first plunger 11A is in contact with the rider 7 by being biased with an elastic body (a first elastic body; such as a compression coil spring) 19 (19A). Moreover, the first plunger 11A is configured to form a sliding pair with the rider 7 and to move in such a direction to come close to the rotation center axis C1 of the drive shaft 5 in response to the rotation of the drive shaft 5, and thereby to introduce the fuel into the first cylinder chamber 17A.

In addition, the first plunger 11A is configured to form a rolling pair with the rider 7 and to move in such a direction to recede from the rotation center axis C1 of the drive shaft 5 against the biasing force of the compression coil spring 19A by use of a pressing force from the rider 7 in association with the rotation of the drive shaft 5, and thereby to compress the fuel in the first cylinder chamber 17A.

The second cylinder (a second cylinder structural member) 9B is integrated with the housing 3 on the opposite side from the first cylinder 9A while interposing the drive shaft 5 in between.

The second plunger 11B is provided reciprocably to the second cylinder 9B, as with the first plunger 11A, on the opposite side from the first plunger 11A while interposing the drive shaft 5 in between. The second plunger 11B and the second cylinder 9B collectively form a second cylinder chamber 17 (17B) which is similar to the first cylinder chamber 17A.

Meanwhile, as with the first plunger 11A, the second plunger 11B is operated by an elastic body (a second elastic body; such as a compression coil spring) 19 (19B) and the rotation of the drive shaft 5, and is configured to perform the fuel compression and the like by using the second cylinder chamber 17 (17B).

Only the two cylinder chambers 17 are provided to one diesel fuel pump 1. Moreover, the diesel fuel pump 1 is configured such that the fuel is introduced into (or compressed in) the second cylinder chamber 17B while the fuel is compressed in (or introduced into) the first cylinder chamber 17A by the rotation of the drive shaft 5. Here, the two cylinder chambers 17 are formed into the same structure. As understood already, the two cylinder chambers 17 are disposed substantially symmetrical to each other with respect to the rotation center axis C1 of the drive shaft 5.

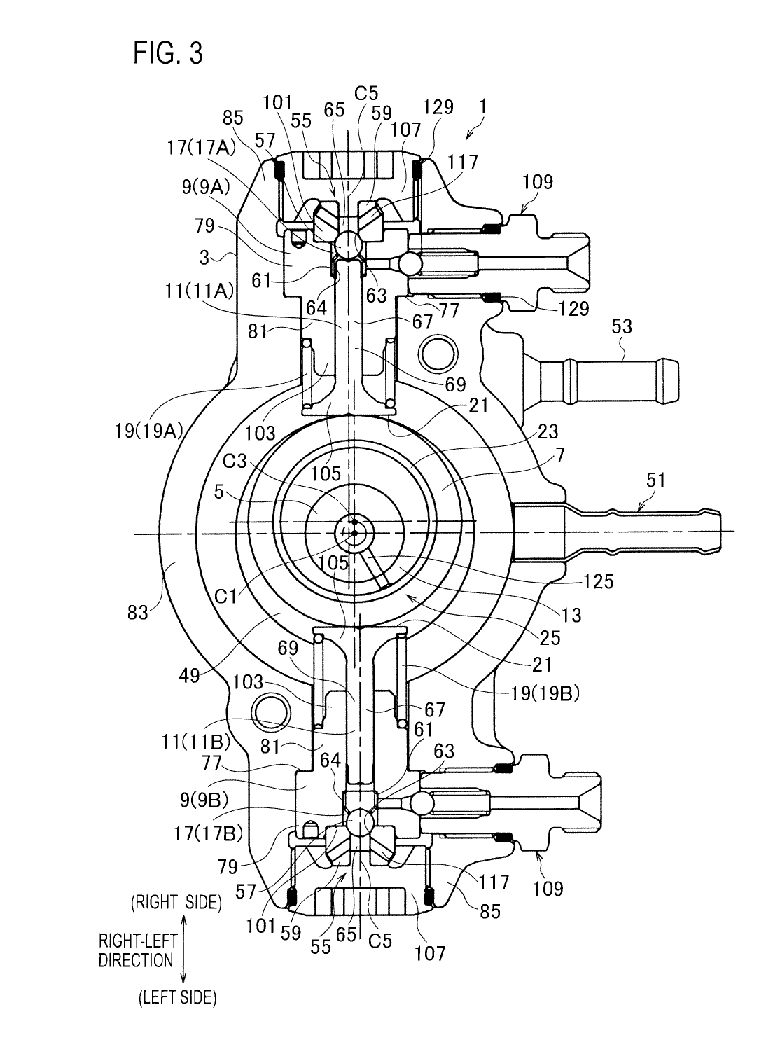

To describe further in detail, while the drive shaft 5 is rotated in a constant direction to 180° from a point where the drive shaft 5 is set to a predetermined rotation angle (an original rotation angle) (when the drive shaft 5 is rotated by 180° from the state shown in FIG. 3 and the rotation angle of the drive shaft 5 is set to 0°), the first plunger 11A is pressed by the rider 7 and thereby moves in the direction to recede from the rotation center axis C1 of the drive shaft 5 (an upward direction in FIG. 3). Accordingly, the fuel is compressed in the first cylinder chamber 17A. The compressed fuel is ejected from the first cylinder chamber 17A. Meanwhile, the second plunger 11B is pressed by the compression coil spring 19B and thereby moves in the direction to come close to the rotation center axis C1 of the drive shaft 5 (the upward direction in FIG. 3). Accordingly, the fuel is introduced into the second cylinder chamber 17B.

In the meantime, while the drive shaft 5 is rotated in the constant direction to 360° from the point where the drive shaft 5 is rotated by 180° from the original rotation angle (which is the state shown in FIG. 3), the first plunger 11A is pressed by the compression coil spring 19A and thereby moves in the direction to come close to the rotation center axis C1 of the drive shaft 5 (a downward direction in FIG. 3), whereby the fuel is introduced into the first cylinder chamber 17A. Then, the second plunger 11B is pressed by the rider 7 and thereby moves in the direction to recede from the rotation center axis C1 of the drive shaft 5 (the downward direction in FIG. 3). Accordingly, the fuel is compressed in the second cylinder chamber 17B. Then, the compressed fuel is ejected from the second cylinder chamber 17B.

Here, the fuel is a liquid such as light oil and can be deemed as a non-compressible fluid. When the fuel in the first cylinder chamber 17A is compressed and the fuel is introduced into the second cylinder chamber 17B, a pressure value occurring between the first plunger 11A and the rider 7 (magnitude of the force of the first plunger 11A pressing the rider 7) is greater than a pressure value occurring between the second plunger 11B and the rider 7 (magnitude of the force of the second plunger 11B pressing the rider 7).

In addition, the rider 7 is rotatable relative to the rider shaft 13. For this reason, the first plunger 11A and the rider 7 mutually form the rolling pair when the fuel in the first cylinder chamber 17A is compressed and the fuel is introduced into the second cylinder chamber 17B. At this time, the second plunger 11B and the rider 7 mutually form a sliding pair.

On the other hand, when the fuel in the second cylinder chamber 17B is compressed and the fuel is introduced into the first cylinder chamber 17A, the second plunger 11B and the rider 7 mutually form the rolling pair while the first plunger 11A and the rider 7 mutually form the sliding pair.

One end (a base end; an end close to the drive shaft 5) of each of the plungers 11 is provided with a planar portion 21 which comes into contact with the rider 7. The planar portion 21 is made parallel to the rotation center axis C1 of the drive shaft 5. Moreover, the planar portion 21 of the first plunger 11A and the planar portion 21 of the second plunger 11B are made parallel to each other and opposed to each other while interposing the rotation center axis C1 of the drive shaft 5 in between. Nevertheless, a distance between the planar portion 21 of the first plunger 11A and the rotation center axis C1 of the drive shaft 5 and a distance between the planar portion 21 of the second plunger 11B and the rotation center axis C1 of the drive shaft 5 are made variable depending on the rotation of the drive shaft 5.

A moving direction of the first plunger 11A engaged with the first cylinder 9A (a moving direction associated with the rotation of the drive shaft 5) and a moving direction of the second plunger 11B engaged with the second cylinder 9B (a moving direction associated with the rotation of the drive shaft 5) are orthogonal to the planar portions 21.

Strokes of reciprocating motions of the plungers 11 associated with the rotation of the drive shaft 5 are equal to each other and ranges of a change in distance of the plungers 11 from the rotation center axis C1 of the drive shaft 5 are equal to each other, respectively. Meanwhile, when the distance between the first plunger 11A (the planar portion 21 of the first plunger 11A) and the rotation center axis C1 of the drive shaft 5 becomes the smallest, the distance between the second plunger 11B (the planar portion 21 of the second plunger 11B) and the rotation center axis C1 of the drive shaft 5 becomes the largest. On the other hand, when the distance between the first plunger 11A and the rotation center axis C1 of the drive shaft 5 becomes the largest, the distance between the second plunger 11B and the rotation center axis C1 of the drive shaft 5 becomes the smallest.

Meanwhile, the planar portion 21 of the first plunger 11A and a generating line on the outer peripheral surface of the rider 7 come into contact with each other. Accordingly, the first plunger 11A and the rider 7 come into line contact with each other. In reality, the planar portion 21 of the first plunger 11A presses the outer peripheral surface of the rider 7. As a consequence, the planar portion 21 of the first plunger 11A and the rider 7 are slightly elastically deformed according to the Hertz contact theory, whereby the first plunger 11A and the rider 7 come into surface contact with each other. Likewise, the second plunger 11B and the rider 7 come into surface contact with each other.

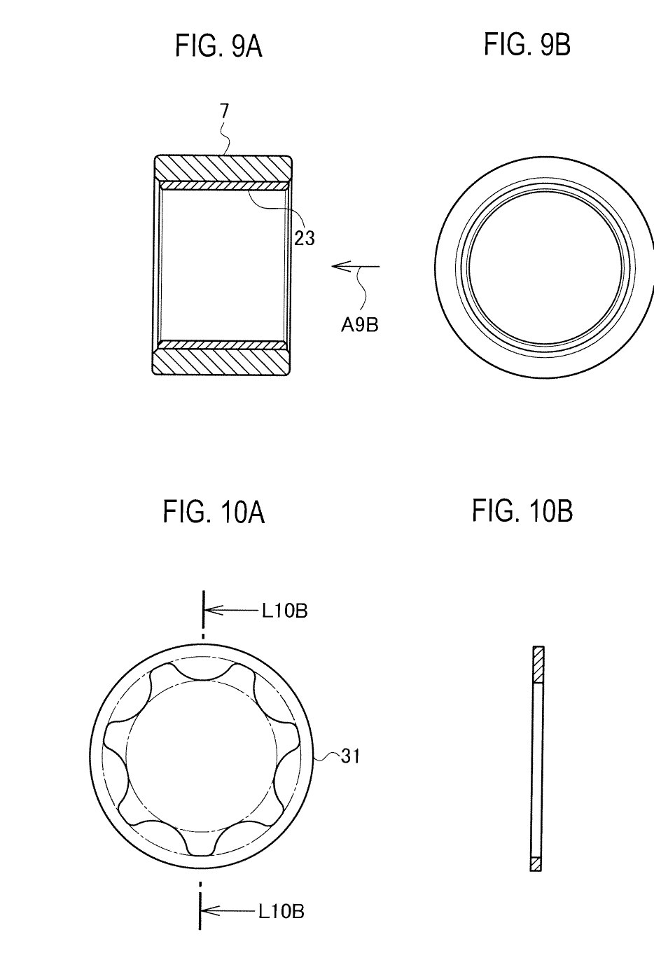

An aspect of the engagement between the rider shaft 13 and the rider 7 will be described in detail. The rider shaft 13 and the rider 7 are engaged with each other while mutually forming the sliding pair not by use of any rolling bearings but through a bush (such as a copper alloy-based metal bush) 23 (see FIG. 9A and FIG. 9B as well) instead.

Meanwhile, the diesel fuel pump 1 is provided with a forced lubrication unit 25. The forced lubrication unit 25 is configured to perform forced lubrication using the fuel at a region where the rider 7 and the rider shaft 13 are engaged with each other while mutually forming the sliding pair (on a boundary surface between the rider 7 and the rider shaft 13).

The forced lubrication unit 25 is provided to the housing 3. The forced lubrication unit 25 is configured to forcibly supply the fuel (configured to increase the pressure of the fuel and to supply the fuel with the increased pressure) to the region (a boundary surface) where the rider 7 (the bush 23) and the rider shaft 13 mutually form the sliding pair by using a pump (a low-pressure pump) 27 to be driven by the rotation of the drive shaft 5.

Here, the fuel is supplied from a not-illustrated fuel tank to the low-pressure pump 27 through a fuel joint 53.

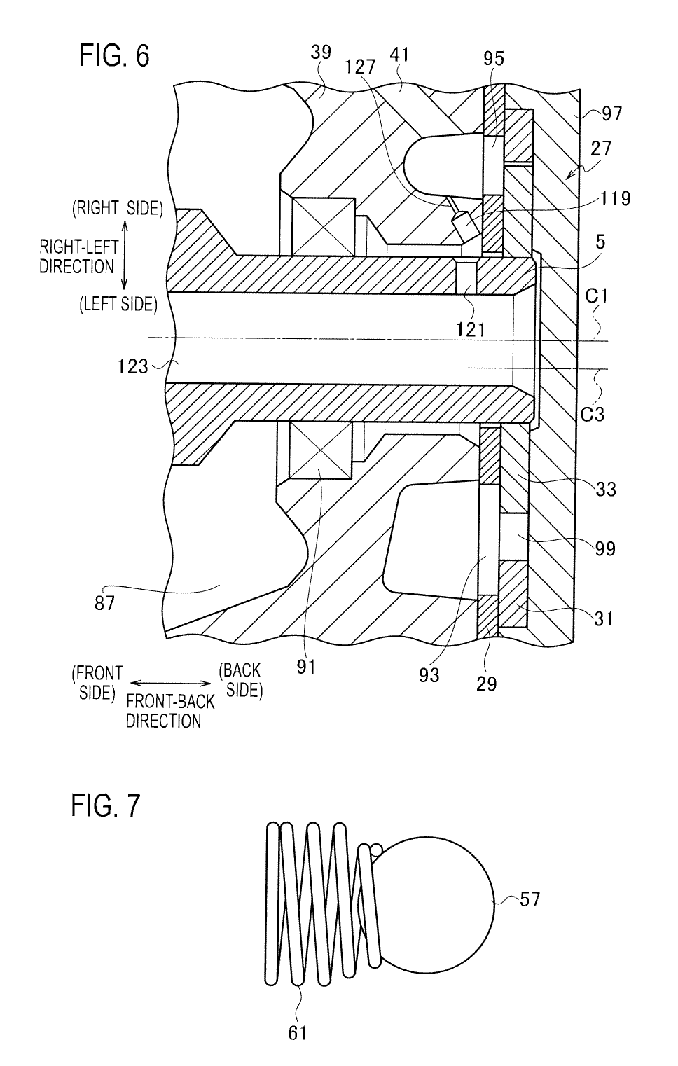

The low-pressure pump 27 is a trochoid pump which includes a pump base 29, an outer rotor 31, and an inner rotor 33 (see FIG. 6). All of the pump base 29, the outer rotor 31, and the inner rotor 33 are formed by: blanking these components out of a flat steel plate by fine pressing, the steel plate having two surfaces in the thickness direction subjected to finish processing (such as polishing); and burring the blanked components.

Here, the low-pressure pump 27 may be produced by forming at least one of the pump base 29, the outer rotor 31, and the inner rotor 33 by subjecting a flat-plate material to the fine pressing.

The fuel pressurized to a low pressure by the trochoid pump 27 is also supplied to the cylinder chambers 17. Specifically, the fuel pressurized to the low pressure by the trochoid pump 27 passes through a low-pressure fuel path 35 provided to the housing 3, and reaches the cylinder chambers 17. The reaching fuel is introduced into the cylinder chambers 17 by a negative pressure in the cylinder chambers 17 generated by the movement of the plungers 11.

Here, the extending direction of the rotation center axis C1 of the drive shaft 5 is defined as a front-back direction for the convenience of description. From the front side toward the back side in the front-back direction, an input unit (a region to which a rotational drive force is inputted from the diesel engine) 37, the primary rolling bearing (such as a cylindrical roller bearing) 15A, the rider shaft 13, the secondary rolling bearing (such as a deep-groove ball bearing) 15B, and the trochoid pump 27 are arranged in this order in the drive shaft 5.

Part of the low-pressure fuel path 35 provided to the housing 3 is formed into a ring-like shape and provided at a region where an outer ring of the rolling bearing (such as the deep-groove ball bearing) 15B is engaged with.

To describe further in detail, the low-pressure fuel produced by the trochoid pump 27 passes sequentially through a low-pressure fuel path 41 provided to a cover 39 and the low-pressure fuel path 35 provided to the housing 3, and reaches each of the pair of cylinder chambers 17. In the light of the front-back direction, the cylinder chambers 17 are provided near the rider shaft 13 while the low-pressure fuel path 35 of the housing 3 is provided in a range from a rear end of the housing 3 to the cylinder chambers 17 (provided near the secondary rolling bearing 15B).

A ring-shaped groove 43 that constitutes part of the low-pressure fuel path of the housing 3 is provided to the region having a columnar side surface (an inner peripheral surface of an internal space formed in the housing 3) where the outer ring of the secondary rolling bearing 15B is engaged with. The ring-shaped groove 43 is formed by cutting work, for example. The ring-shaped groove 43 is recessed outward from the inner peripheral surface where the secondary rolling bearing 15B is engaged with (the radius of the groove 43 is made greater than the radius of the inner peripheral surface), and is located at a central part of the inner peripheral surface in terms of the front-back direction. As a consequence, when the secondary bearing 15B is installed in the housing 3, the ring-shaped groove 43 is closed by the outer ring of the secondary bearing 15B. Thus, the ring-shaped groove 43 is formed into a ring-shaped space surrounded by a body part of the housing 3 and the outer ring of the secondary bearing 15B.

Meanwhile, the low-pressure fuel path 41 of the cover 39 is formed form one hole provided in a body part of the cover 39. The low-pressure fuel path 35 of the housing 3 is formed from the ring-shaped groove 43, and one first passage (hole) 45 as well as two second passages (holes) 47 provided in the body part of the housing 3.

Moreover, the low-pressure fuel pressurized by the trochoid pump 27 passes through the low-pressure fuel path 41 of the cover 39 and the one first passage 45 of the housing 3, and reaches the space formed by the ring-shaped groove 43 of the housing 3. The low-pressure fuel is split into two routes by the ring-shaped space in the housing 3. One route passes through the primary second passage 47 and reaches the first cylinder chamber 17A, while the other route passes through the secondary second passage 47 and reaches the second cylinder chamber 17B.

Meanwhile, the fuel leaks very slightly out to an internal space (the space in which the rider 7, the rolling bearings 15, the compression coil springs 19 for biasing the plungers 11, and the like are provided) 49 of the housing 3 by the compression inside the cylinder chambers 17. In addition, the fuel comes out to the internal space 49 of the housing 3 due to the forced lubrication by the forced lubrication unit 25. The fuel passes through a return unit (a return joint) 51 provided to the housing 3 (see FIG. 3) and returns to the not-illustrated fuel tank.

Moreover, the diesel fuel pump 1 is provided with ball-type non-return valves (ball-type check valves) 55.

Each ball-type non-return valve 55 includes a spherical ball 57, a valve seat 59, and a compression coil spring 61. The ball 57 is made of steel or a ceramic, for example.

The valve seat 59 is integrated with the cylinder 9. Moreover, the valve seat 59 includes a through-hole 65, which is provided with an inner surface 63 having a truncated cone-shaped side surface. Here, an apex angle of the truncated cone of the inner surface 63 having the truncated cone-shaped side surface is set to 60° in a side view, for example.

The compression coil spring 61 is provided inside the cylinder chamber 17, and one end (first end portion) thereof comes into contact with the ball 57 while the other end (second end portion) thereof comes into contact with a step 64 of the cylinder 9. A value of a winding diameter (a coil diameter) of the compression coil spring 61 is not constant. Specifically, the value is small at the one end portion (the region in contact with the ball 57) while the value is large in a region except the one end portion (a section between the one end portion and the other end portion; a range from a region in the vicinity of the one end portion adjacent to the one end portion to the region near the other end portion) (see FIG. 7 as well).

Moreover, when the fuel is compressed in the cylinder chamber 17, the ball 57 is pressed to the truncated cone side surface-shaped inner surface 63 of the through-hole 65 of the valve seat 59 by the compression coil spring 61 and comes into contact therewith, whereby the through-hole 65 of the valve seat 59 is closed. When the fuel is introduced into the cylinder chamber 17, the compression coil spring 61 is compressed whereby the ball 57 is detached from the truncated cone side surface-shaped inner surface 63 of the through-hole 65 of the valve seat 59. As a consequence, the through-hole 65 of the valve seat 59 is opened and the fuel passes therethrough.

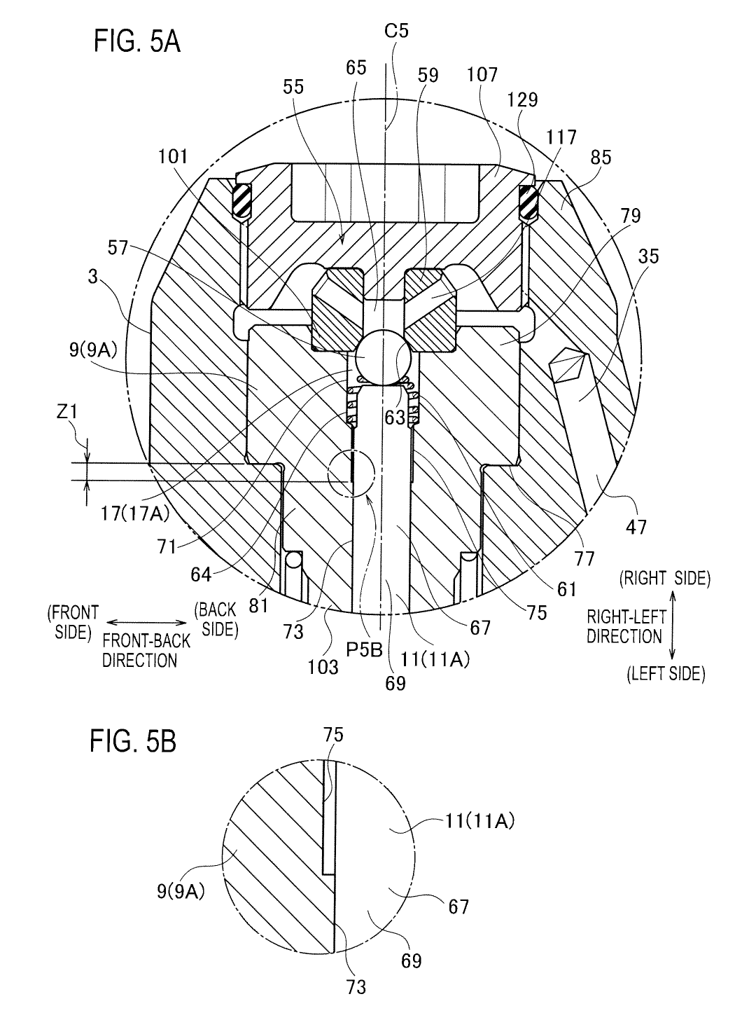

To describe further in detail, when the plunger 11 moves in one direction to compress the fuel, the ball 57 is pressed against the truncated cone side surface-shaped inner surface 63 of the through-hole 65 of the valve seat 59 by the pressure of the fuel and by the compression coil spring 61. Accordingly, the through-hole 65 of the valve seat 59 is closed so as to block the passage of the fuel in the through-hole 65 of the valve seat 59. Here, when the plunger 11 completes movement in one direction (when the plunger 11 is located on a remote end side from the rider shaft 13 during a reciprocating motion), a tip end portion (an end portion on the ball 57 side opposite from the planar portion 21) of an elongated columnar region (a region extending out of the planar portion 21) 67 of the plunger 11 is designed to enter the inside of the compression coil spring 61 (into the region where the value of the winding diameter is large) in order to increase a compression ratio of the fuel (see the first plunger 11A in FIGS. 2 and 5A).

On the other hand, as the plunger 11 moves in the other direction, the volume of the cylinder chamber 17 is increased and the pressure therein is reduced. Accordingly, the ball 57 moves and thereby compresses the compression coil spring 61. As a consequence, the ball 57 is detached from the truncated cone side surface-shaped inner surface 63 of the through-hole 65 of the valve seat 59, so that the fuel can pass through the through-hole 65 of the valve seat 59.

Here, the winding radius of the compression coil spring 61 of the ball-type non-return valve 55 is reduced at a portion to receive the ball 57 (only at the portion to receive the ball 57 and a position in the vicinity thereof, for example).

To describe further in detail, the end portion of the compression coil spring 61 is formed into a closed end (is ground). Specifically, the grinding or the like is performed on the end portion while bringing spring lines only at the end portion into contact with adjacent winds while changing winding angles thereof. Accordingly, the ball 57 is stably fitted to the end portion. Moreover, the winding diameter of the compression coil spring 61 is reduced only at the one end portion (in a range of one round, for example). Here, the winding diameter of a portion of the compression coil spring 61 located away from the one end is gradually increased only within a range of one round adjacent to the one end portion. After the diameter is increased, the value of the increased winding diameter is kept constant. In other words, the compression coil spring 61 is formed into the cylindrical coil spring with the constant winding diameter except the two rounds at the one end portions.

The cylinder 9 is formed into a cylindrical shape and is provided with a through-hole 69 where the plunger 11 enters. Here, the through-hole 69 penetrates the cylinder 9 along the center axis C5 thereof.

To describe further in detail, as shown in FIG. 5A, the through-hole 69 of the cylinder 9 includes: a first region (a first columnar space) 71 provided at one end portion (third end portion) in the extending direction of the center axis C5 of the cylinder 9 (in the direction of the reciprocating motion of the plunger 11); a second region (a second columnar space) 73 provided at the other end portion (fourth end portion) in the extending direction of the center axis C5 of the cylinder 9; and a third region (a third columnar space) 75 formed between the first region 71 and the second region 73.

The compression coil spring 61 of the ball-type non-return valve 55 enters and thereby comes into engagement with the first region 71. An inside diameter of the second region 73 is made smaller than an inside diameter of the first region 71 and slightly larger than an outside diameter of an elongated columnar region 67 of the plunger 11. The plunger 11 (the elongated columnar region 67) enters the second region 73 and comes into engagement therewith while forming a sliding pair, for example, for the reciprocating motion. An inside diameter of the third region 75 is made smaller than the inside diameter of the first region 71 and slightly larger than an inside diameter of the second region 73 (see FIG. 5B). The step 64 where the compression coil spring 61 comes into contact with is formed between the first region 71 and the third region 75.

Here, description will be made further in detail while defining a certain direction orthogonal to the front-back direction as a right-left direction for the convenience of description.

From the rotation center axis C1 of the drive shaft 5 to the right side in the right-left direction, the rider shaft 13, the rider 7, the first plunger 11A, the first cylinder chamber 17A, and the ball-type non-return valve 55 are arranged in this order.

Of the first plunger 11A, the planar portion 21 is located on the rotation center axis C1 side (the left side) of the drive shaft 5 and the columnar region 67 projects to the right side from the planar portion 21. The through-hole 65 provided to the valve seat 59 of the ball-type non-return valve 55 penetrates a body part of the valve seat 59 in the right-left direction. The truncated cone side surface-shaped inner surface 63 of the through-hole 65 is provided at an end portion of the through-hole 65 (an end portion on the left side; an end portion on the first plunger 11A side), and faces the first cylinder chamber 17A. Accordingly, a value of an inside diameter of the through-hole 65 is the largest on the first plunger 11A side, then becomes gradually smaller as it goes away from the first plunger 11A (toward the right side), and is set at a constant value after the inside diameter is reduced to a predetermined value.

The ball 57 of the ball-type non-return valve 55 is provided on the valve seat 59 side and between the valve seat 59 and the plunger 11A. The compression coil spring 61 of the ball-type non-return valve 55 is provided at a position closer to the plunger 11A (the drive shaft 5) than the ball 57 is. Moreover, the compression coil spring 61 biases the ball 57 such that the ball 57 presses the truncated cone side surface-shaped inner surface 63 of the through-hole 65.

The first cylinder chamber 17A is a space surrounded by an inner wall of the first cylinder 9A, the ball-type non-return valve 55, and the first plunger 11A. The volume of the first cylinder chamber 17 is made variable by the movement of the first plunger 11A in the right-left direction associated with the rotation of the drive shaft 5. To describe further in detail, when the first plunger 11A moves in the direction away from the drive shaft 5 (to the right) by the rotation of the drive shaft 5, the volume of the first cylinder chamber 17A is reduced so as to compress the fuel.

Here, it is also possible to say that the ball 57 and the compression coil spring 61 of the ball-type non-return valve 55 are provided inside the first cylinder chamber 17A.

Meanwhile, the second plunger 11B, the second cylinder chamber 17B, and the ball-type non-return valve 55 on the second cylinder chamber 17B side are arranged symmetrically to the first plunger 11A, the first cylinder chamber 17A, and the ball-type non-return valve 55 on the first cylinder chamber 17A side with respect to the rotation center axis C1 of the drive shaft 5. In other words, from the rotation center axis C1 of the drive shaft 5 to the left side in terms of the right-left direction, the rider shaft 13, the rider 7, the second plunger 11B, the second cylinder chamber 17B, and the ball-type non-return valve (the ball-type non-return valve different from the ball-type non-return valve 55 on the right side) 55 are arranged in this order.

A step 77 is formed on the outer periphery of each cylinder 9. An outside diameter of a region 79 closer to one end side (third end portion side) than the step 77 is made larger than an outside diameter of a region 81 closer to the other end side (fourth end portion side) than the step 77 in terms of the direction of extension of the center axis C5 of the cylinder 9 (the right-left direction; the direction of the reciprocating motion of the corresponding plunger 11). The region 79 closer to the one end side than the step 77 is engaged with the housing 3 (the region 79 closer to the one end side is press-fitted into the housing 3, for example). Thus, the cylinder 9 is integrated with (installed in) the housing 3. Meanwhile, in the right-left direction, a boundary between the second region 73 and the third region 75 of the through-hole 69 of the cylinder 9 is provided closer to the drive shaft 5 than the step 77 is.

In other words, the step 77 is formed on the outer periphery of the first cylinder 9A, and the outside diameter of the region 79 on the right side of the step 77 is formed larger than the outside diameter of the region 81 on the left side of the step 77 in terms of the right-left direction. Since the region 79 on the right side of the step 77 is fitted into the housing 3, the first cylinder 9A is integrated with the housing 3. Meanwhile, in the right-left direction, the step 77 is provided on the right side of the boundary between the second region 73 and the third region 75 of the through-hole 69 of the first cylinder 9A.

On the other hand, the step 77 is formed on the outer periphery of the second cylinder 9B, and the outside diameter of the region 79 on the left side of the step 77 is formed larger than the outside diameter of the region 81 on the right side of the step 77 in terms of the right-left direction. Since the region 79 on the left side of the step 77 is engaged with the housing 3, the second cylinder 9B is integrated with the housing 3. Meanwhile, in the right-left direction, the step 77 is provided on the left side of the boundary between the second region 73 and the third region 75 of the through-hole 69 of the second cylinder 9B.

Incidentally, the third region 75 of the through-hole 69 of each cylinder 9 may be omitted. In this case, a boundary between the first region 71 and the second region 73 is provided closer by a dimension Z1 indicated in FIG. 5A to the drive shaft 5 than the step 77 is.

Now, the diesel fuel pump 1 will be described further in detail.

The housing 3 includes a cylindrical body portion 83, and a pair of cylinder installation portions 85 formed into a cylindrical shape and projecting in the right-left direction from an intermediate portion of the body portion 83. Here, a space inside the cylindrical body portion 83 and an internal space defined by the pair of cylinder installation portions 85 in the cylindrical shape are connected to each other, and a rear end surface of the housing 3 is formed into a planar shape.

A front end surface of the cover 39 is formed into a flat surface. The flat surface comes into surface contact with the rear end surface of the housing 3. Thus, the cover 39 is integrated with the housing 3 on the back of the housing 3. In the meantime, a rear end surface of the cover 39 is also formed into a flat surface, and a through-hole 87 is formed in the cover 39 in such a way as to penetrate a central part of the cover 39 in the front-back direction. The through-hole 87 is connected to the internal space of the body portion 83 of the housing 3.

In the drive shaft 5, the tapered input unit 37, a first oil seal engagement unit, a first bearing engagement unit in which the primary rolling bearing (the first rolling bearing) 15A is installed, the rider shaft 13, a second bearing engagement unit in which the secondary rolling bearing (the second rolling bearing) 15B is installed, a second oil seal engagement unit, and an inner rotor installation unit in which the inner rotor 33 of the trochoid pump 27 is integrally installed, are arranged in this order from the front side to the back side. Here, the tapered input unit 37 projects forward from the body portion 83 of the housing 3. The first oil seal engagement unit, the first bearing engagement unit for the first rolling bearing 15A, the rider shaft 13, and the second bearing engagement unit for the second rolling bearing 15B are located inside the body portion 83 of the housing 3. The second oil seal engagement unit is located inside the cover 39. The inner rotor installation unit slightly projects backward from the cover 39 but is located inside the trochoid pump 27.

A pulley (not shown) is installed in the tapered input unit 37, and the drive shaft 5 is rotated by a belt wound around this pulley.

A first oil seal 89 disposed inside the body portion 83 of the housing 3 is engaged with the first oil seal engagement unit of the drive shaft 5. A second oil seal 91 disposed in the cover 39 is engaged with the second oil seal engagement unit of the cover 39. The first oil seal 89 prevents the fuel from leaking forward from the inside of the body portion 83 of the housing 3. Working of the second oil seal 91 will be described later.

Meanwhile, the first bearing engagement unit of the drive shaft 5 is fitted to the first rolling bearing 15A disposed inside the body portion 83 of the housing 3. The second bearing engagement unit of the drive shaft 5 is fitted to the second rolling bearing 15B disposed inside the body portion 83 of the housing 3. As a consequence, the drive shaft 5 is made rotatable with respect to the housing 3 and the cover 39. Here, the internal space 49 is defined between the first rolling bearing 15A and the second rolling bearing 15B.

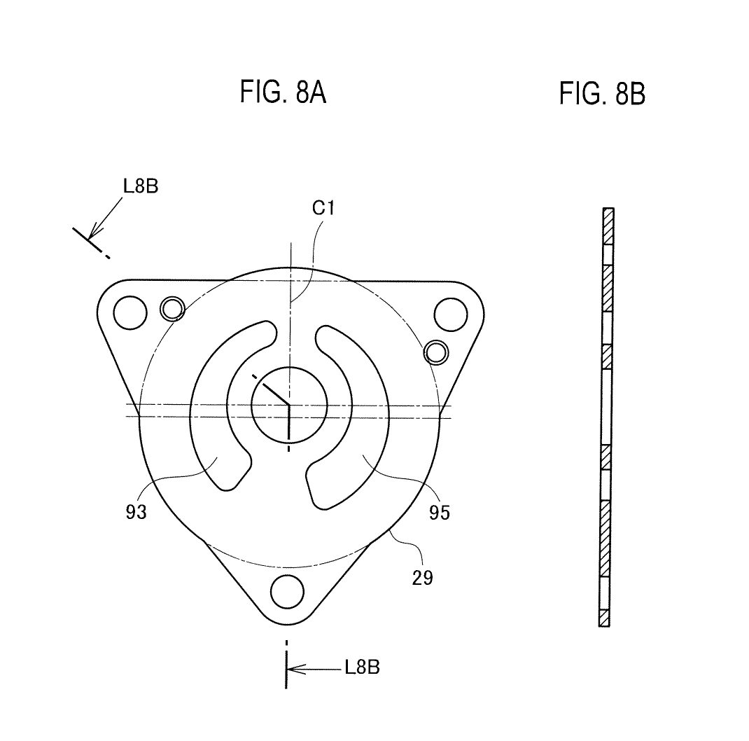

As shown in FIGS. 8A and 8B, the pump base 29 is formed into a triangular flat plate shape. A circular through-hole to allow penetration of the drive shaft 5 is formed at a central part of the pump base 29. A through-hole 93 for supplying the fuel to the trochoid pump 27 is provided on one side of the aforementioned through-hole, and a through-hole 95 to allow passage of the fuel with the increased pressure by the trochoid pump 27 is provided on the other side of the aforementioned through-hole.

Meanwhile, one surface in a thickness direction of the pump base 29 is in contact with the rear end surface of the cover 39. Thus, the pump base 29 is integrated with the cover 39.

A pump case 97 is formed into a triangular flat plate shape as with the pump base 29. However, the pump case 97 is thicker than the pump base 29, and a disc-shaped recess 99 that allows entry of the outer rotor 31 and the inner rotor 33 is formed on one surface in the thickness direction of the pump case 97.

Meanwhile, a planar portion at a front end of the pump case 97 is in contact with one surface (a rear end surface) in the thickness direction of the pump base 29. Thus, the pump case 97 is integrated with the pump base 29. To describe further in detail, the cover 39, the pump base 29, and the pump case 97 are integrated with the housing 3 by using bolts.

As shown in FIGS. 10A and 10B, the outer periphery of the outer rotor 31 is formed into a circular shape. Moreover, a through-hole that penetrates the outer rotor 31 in the thickness direction is formed at a central part thereof. Multiple teeth are formed on the inner periphery of this through-hole. Here, an outside diameter of the outer rotor 31 is made slightly smaller than an inner diameter of the recess 99 of the pump case 97. A thickness of the outer rotor 31 is made slightly smaller than a depth of the recess 99 of the pump case 97. Moreover, the outer rotor 31 enters the recess 99 of the pump case 97 as shown in FIG. 2, and is thus made rotatable relative to the pump case 97.

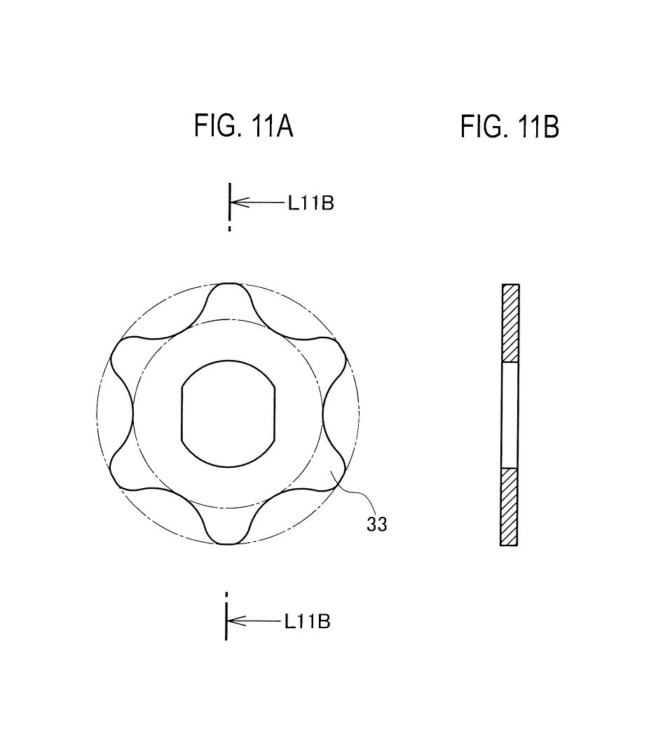

As shown in FIGS. 11A and 11B, multiple teeth are formed on the outer periphery of the inner rotor 33. A thickness of the inner rotor 33 is equal to the thickness of the outer rotor 31. The inner rotor 33 is located inside the outer rotor 31, and a few of the teeth of the inner rotor 33 mesh with a few of the teeth of the outer rotor 31. Moreover, the inner rotor 33 is engaged with the drive shaft 5 and is configured to be rotated in accordance with the rotation of the drive shaft 5.

When the inner rotor 33 is rotated, the outer rotor 31 is rotated at a slower rotational angular velocity than that of the inner rotor 33. Hence, the teeth meshing with one another are shifted as appropriate whereby the figure of a space between the outer rotor 31 and the inner rotor 33 changes as appropriate. This change introduces the fuel from the through-hole 93 of the pump base 29 into the space between the outer rotor 31 and the inner rotor 33. The introduced fuel is compressed at the low pressure and is ejected from the through-hole 95 of the pump base 29.

As described previously, each cylinder 9 is provided with the large-diameter region 79 and the small-diameter region 81, and the step 77 is thereby formed on the outer periphery of the cylinder 9. As described previously, the through-hole 69 of the cylinder 9 includes the first region 71, the second region 73, and the third region 75. Here, a columnar recess 101 for allowing entry of the valve seat 59 is formed at an end portion (which is a right end portion in the case of the first cylinder 9A or a left end portion in the case of the second cylinder 9B) of the first region 71.

Meanwhile, a columnar region 103 to be engaged with one end portion of the compression coil spring 19 to bias the plunger 11 is formed at an end portion (which is a left end portion in the case of the first cylinder 9A or a right end portion in the case of the second cylinder 9B) of the small-diameter region 81. An outside diameter of the region 103 is made smaller than an outside diameter of the small-diameter region 81 and substantially equal to an inside diameter of the compression coil spring 19.

As described previously, the large-diameter region 79 of each cylinder 9 is fitted into the through-hole of the corresponding cylinder installation portion 85 of the housing 3, and is thereby integrated with the housing 3. The through-hole 69 of each cylinder 9 extends in the right-left direction.

Each plunger 11 includes a disc-shaped region 105 constituting the planar portion 21, and the small-diameter columnar region 67 projecting to one side from a central part of the disc-shaped region 105.

Regarding the first plunger 11A, the disc-shaped region 105 is located on the left side while the columnar region 67 projects to the right side in such a way that the columnar region 67 enters the through-hole 69 of the first cylinder 9A. Thus, the first plunger 11A is made movable in the right-left direction with respect to the cylinder 9.

Regarding the second plunger 11B, the disc-shaped region 105 is located on the right side while the columnar region 67 projects to the left side in such a way that the columnar region 67 enters the through-hole 69 of the second cylinder 9B. Thus, the second plunger 11B is made movable in the right-left direction with respect to the cylinder 9.

As described previously, the one end portion of each compression coil spring 19 is engaged with the corresponding cylinder 9 while the other end portion thereof is in contact with the disc-shaped region 105 of the corresponding plunger 11. Thus, each plunger 11 is biased toward the drive shaft 5 and the planar portion 21 of each plunger 11 comes into contact with the outer periphery of the rider 7 and presses the rider 7.

The internal space 49 of the housing 3 is defined between the first cylinder 9A and the second cylinder 9B. The planar portions 21 of the plungers 11 and the compression coil springs 19 are located inside the internal space 49.

Each valve seat 59 is formed into the cylindrical shape, and constitutes the ball-type non-return valve 55 as described previously. One end portion of the valve seat 59 enters the columnar recess 101 of the cylinder 9.

Each head plug 107 is formed into a columnar shape with its outer periphery provided with a male screw. The male screw is threadedly engaged with a female screw formed on an inner periphery of the cylinder installation portion 85 of the housing 3. Thus, the head plug 107 is integrated with the housing 3. To describe further in detail, the head plug 107 is provided outside of the cylinder 9 and the valve seat 59 (on the remote side from the drive shaft 5). Then, the valve seat 59 and the cylinder 9 are pressed toward the drive shaft 5 by the head plug 107. The step 77 on the outer periphery of the cylinder 9 is in contact with a step of the cylinder installation portion 85 of the housing 3. Thus, the housing 3, the cylinder 9, the valve seat 59, and the head plug 107 are integrated together.

As shown in FIG. 3, the housing 3 is provided with a pair of out connectors 109 each formed in a similar manner to the ball-type non-return valve 55. One of the out connectors 109 is connected to the first cylinder chamber 17A. The fuel compressed in the first cylinder chamber 17A is ejected through the one out connector 109. The other out connector 109 is connected to the second cylinder chamber 17B. The fuel compressed in the second cylinder chamber 17B is ejected through the other out connector 109.

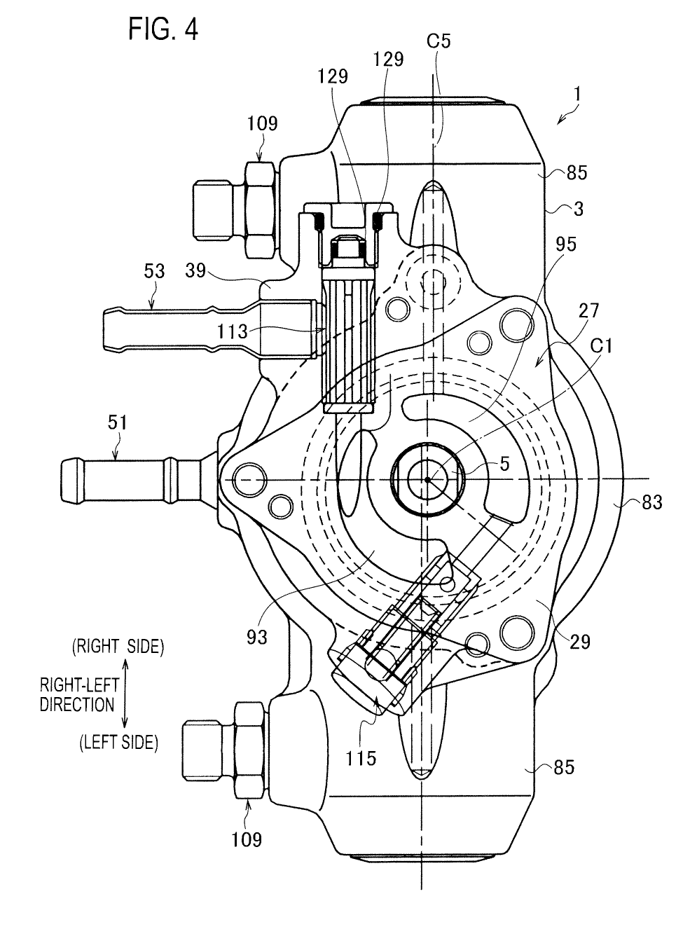

Moreover, the cover 39 is provided with the fuel joint 53, and the fuel is supplied to the diesel fuel pump 1 through the fuel joint 53. Specifically, the fuel having passed through the fuel joint 53 further passes through a filter 113 provided to the cover 39, and is then supplied to the trochoid pump 27. Here, as shown in FIG. 4, the through-hole 93 and the through-hole 95 of the pump base 29 are connected to each other through a check valve 115. When a pressure inside the through-hole 95 becomes too high, part of the fuel is guided to the through-hole 93, and the pressure of the fuel to be ejected from the trochoid pump 27 is thus set equal to or below a predetermined value.

Part of the fuel pressurized to the low pressure by the trochoid pump 27 passes through the low-pressure fuel path 41 formed in the cover 39, the low-pressure fuel path 35 formed in the housing 3, and a through-hole 117 as well as the through-hole 65 formed in the valve seat 59, and is thus supplied to the cylinder chamber 17.

In the meantime, part of the fuel pressurized to the low pressure by the trochoid pump 27 is used by the forced lubrication unit 25. Specifically, part of the fuel passes through a through-hole 119 provided to the cover 39 and through-holes 121, 123, and 125 provided to the drive shaft 5, and is thus supplied to a space (boundary portion) between the rider shaft 13 and the bush 23 of the rider 7.

Here, as shown in FIG. 6, part of the through-hole 119 is formed into a small-diameter portion 127. Thus, a choke functioning as a throttle valve is thus formed. Accordingly, an amount of the fuel to be supplied to the cylinder chamber 17 is set larger than an amount of the fuel to be supplied by the forced lubrication unit 25.

The second oil seal 91 prevents the fuel ejected from the through-hole 119 from flowing toward the second rolling bearing 15B. A drop in pressure of the fuel to be supplied by the forced lubrication unit 25 is avoided by providing the second oil seal 91.

Here, the diesel fuel pump 1 is provided with a sealing member (such as an O ring) 129 as appropriate in order to prevent the fuel from leaking out of junctions of the components such as the housing 3.

Next, an operation of the diesel fuel pump 1 will be described. When the drive shaft 5 is rotated, the fuel is supplied from the fuel joint 53 to the trochoid pump 27, and the supplied fuel is compressed to the low pressure.

A very small amount of part of the fuel compressed to a low pressure is used by the forced lubrication unit 25, and the remaining fuel is supplied to the cylinder chamber 17.

The fuel supplied to the cylinder chamber 17 is compressed to a high pressure inside the cylinder chamber 17. The compressed fuel is ejected from the out connector 109 to the outside of the diesel fuel pump 1.

Here, a very small amount of part of the fuel compressed in the cylinder chamber 17 passes through a tiny gap between a point of engagement between the cylinder 9 and the plunger 11, and leaks to the inside of the diesel fuel pump 1 such as the internal space 49. The fuel thus leaking out passes through the return unit 51 and is recovered at the outside of the diesel fuel pump 1. Accordingly, the inside of the diesel fuel pump 1 such as the internal space 49 is kept from reaching a high pressure but is maintained at a pressure around the atmospheric pressure.

According to the diesel fuel pump 1, the first plunger 11A compresses the fuel in the first cylinder chamber 17A by using the pressing force of the cylindrical rider 7 in association with the rotation of the drive shaft 5. On the opposite side while interposing the drive shaft 5 in between, the second plunger 11B is configured to compress the fuel in the second cylinder chamber 17B by using the pressing force of the cylindrical rider 7 in association with the rotation of the drive shaft 5. Meanwhile, the rider 7 is configured to be rotated around the rider shaft 13.

Moreover, when the fuel is compressed in the first cylinder chamber 17A and the fuel is introduced into the second cylinder chamber 17B, the first plunger 11A and the rider 7 mutually form the rolling pair while the second plunger 11B and the rider 7 mutually form the sliding pair. On the other hand, when the fuel in the second cylinder chamber 17B is compressed and the fuel is introduced into the first cylinder chamber 17A, the second plunger 11B and the rider 7 mutually form the rolling pair while the first plunger 11A and the rider 7 mutually form the sliding pair.

Thus, it is possible to reduce a mechanical loss of the diesel fuel pump 1 even if there is a large frictional resistance between the rider 7 and the plunger 11 when compressing the fuel (when a large load is applied between the plunger 11 and the rider 7).

Meanwhile, according to the diesel fuel pump 1, the mechanical loss of the diesel fuel pump 1 can be reduced even if there is the large frictional resistance between the rider 7 and the plunger 11. It is therefore possible to reduce starting torque and to deal with a start-stop system easily.

Moreover, according to the diesel fuel pump 1, the rider shaft 13 and the rider 7 are engaged with each other through the bush 23 without using a rolling bearing. Thus, the diesel fuel pump 1 is downsized and the structure of the diesel fuel pump 1 is simplified. As a consequence, it is possible to reduce manufacturing costs of the diesel fuel pump 1.

Furthermore, according to the diesel fuel pump 1, the forced lubrication unit 25 is configured to perform the forced lubrication using the fuel in the region where the rider 7 and the rider shaft 13 are engaged with each other. For this reason, it is possible to perform a high-speed drive (high-speed rotation of the drive shaft 5) and to efficiently compress the fuel. As a consequence, durability of the rider 7 and the rider shaft 13 is improved.

Meanwhile, according to the diesel fuel pump 1, the pump base 29, the outer rotor 31, and the inner rotor 33 are produced by the fine pressing. Thus, the trochoid pump 27 is manufactured easily.

Moreover, according to the diesel fuel pump 1, part of the low-pressure fuel path 35 provided to the housing 3 is formed into the ring-like shape and provided at the region where the outer ring of the second rolling bearing (such as the deep-groove ball bearing) 15B is engaged with. Thus, the low-pressure fuel path 35 can be formed easily.

Furthermore, according to the diesel fuel pump 1, the ball-type non-return valve 55 applying the spherical ball 57 of a commercially available bearing is used instead of a valve body provided with a truncated cone-shaped region. Thus, it is possible to reduce the manufacturing costs.

Meanwhile, according to the diesel fuel pump 1, the one end portion of the compression coil spring 61 of the ball-type non-return valve 55 (the compression coil spring provided to the inside of the cylinder chamber 17) is in contact with the ball 57 of the non-return valve 55 while the other end portion thereof is in contact with the cylinder 9. Moreover, the value of the winding diameter of the compression coil spring 61 is small at the end portion on the ball 57 side while the value of the winding diameter is large in the region except the end portion. For this reason, even when the ball 57 of the non-return valve 55 has a small diameter, the ball 57 can be stably biased toward the truncated cone side surface-shaped inner surface 63 of the valve seat 59, and a value of a stress occurring in the compression coil spring 61 can be reduced as well. In addition, even if the diameter of part (the tip end portion) of the plunger 11 is not reduced, the tip end portion of the plunger 11 enters the inside of the compression coil spring 61 at the time of compressing the fuel. As a consequence, it is possible to increase the compression ratio of the fuel (to increase a ratio between the minimum volume and the maximum volume of the cylinder chamber 17).

Moreover, according to the diesel fuel pump 1, the winding radius of the compression coil spring 61 of the ball-type non-return valve 55 is reduced only at the portion to receive the ball 57 and the position in the vicinity thereof. For this reason, it is possible to further reduce the value of the stress occurring in the compression coil spring 61 when the compression coil spring 61 compressed, and thereby to further improve the compression ratio of the fuel.

Furthermore, according to the diesel fuel pump 1, the third region 75 of the through-hole 69 of the cylinder 9, which is formed between the first region 71 and the second region 73 engaged with the plunger 11, has the inside diameter which is slightly larger than that of the second region 73. In this way, it is possible to reduce the length of the second region 73 (to reduce a ratio between the inside diameter and the height of the columnar second region 73), and to manufacture the cylinder 9 (to perform machining of the second region 73 to be engaged with the plunger 11) easily.

Meanwhile, according to the diesel fuel pump 1, the region 79 closer to the one end portion than the step 77 on the outer periphery of the cylinder 9 is engaged with (fitted to) the housing 3, whereby the cylinder 9 is integrated with the housing 3. Moreover, in the extending direction of the center axis C5 of the cylinder 9, the boundary between the second region 73 and the third region 75 is provided closer to the drive shaft 5 than the step 77 is. For this reason, even when the cylinder 9 is slightly deformed when installing the cylinder 9 in the housing 3, the plunger 11 can smoothly move relative to the cylinder 9.

In the meantime, the diesel fuel pump 1 includes: a cylinder integrated with a housing, a plunger reciprocably provided to the cylinder, and a plunger drive mechanism provided to the housing and configured to drive the plunger (to cause the plunger to perform a reciprocating motion). When the plunger moves in one direction during a reciprocating motion, fuel is compressed in a cylinder chamber formed from the cylinder and the plunger. The compressed fuel is ejected from the cylinder chamber, and the fuel is introduced into the cylinder chamber when the plunger moves in another direction, which is opposite from the one direction, during the reciprocating motion. The plunger drive mechanism includes a drive shaft rotatably provided to the housing and having a rider shaft serving as a driver of a cam, a cylindrical rider. An inner peripheral surface of the rider is engaged with (is in surface contact with) an outer peripheral surface of the rider shaft, and is made rotatable (capable of freely rotating) relative to the rider shaft. An outer peripheral surface of the rider is engaged with (for example, in line contact with) the plunger. The rider shaft and the rider mutually form a sliding pair. When the fuel is compressed in the cylinder chamber by rotating the drive shaft, a contact pressure between the plunger and the rider is increased, and the plunger and the rider are thus configured to mutually form a rolling pair. When the fuel is introduced into the cylinder chamber by rotating the drive shaft, the contact pressure between the plunger and the rider is reduced, and the plunger and the rider are thus configured to mutually form the sliding pair.

In addition, in the diesel fuel pump 1 is provided with a pair of the cylinders and a pair of the plungers, for example, and the plungers are configured to compress the fuel alternately by the rotation of the drive shaft.

Moreover, when one of the plungers is compressing the fuel in one of the cylinder chambers, the other of the plungers is configured to introduce the fuel into the other of the cylinder chambers. Meanwhile, when the one plunger is introducing the fuel into the one cylinder chamber, the other plunger is compressing the fuel in the other cylinder chamber.

Meanwhile, when the one plunger is compressing the fuel in the one cylinder chamber, the contact pressure between the one plunger and the rider is increased and the rider is made rotatable relative to the rider shaft. At this time, the one plunger and the rider mutually form the rolling pair. In the meantime, when the contact pressure between the other plunger and the rider is reduced and the one plunger and the rider are mutually forming the rolling pair, the other plunger and the rider mutually form the sliding pair.

On the other hand, when the other plunger is compressing the fuel in the other cylinder chamber, the contact pressure between the other plunger and the rider is increased. At this time, the other plunger and the rider mutually form the rolling pair. At the same time, the contact pressure between the one plunger and the rider is reduced. Hence, the one plunger and the rider mutually form the sliding pair.

What is claimed is:

1. A diesel fuel pump comprising:
a cylinder provided to a housing;
a plunger configured to form a cylinder chamber in conjunction with the cylinder by being reciprocably provided to the cylinder, to compress fuel inside the cylinder chamber when the plunger moves in a first direction during a reciprocating motion, and to introduce the fuel into the cylinder chamber when the plunger moves in a second direction during the reciprocating motion; and
a ball-type non-return valve including
a spherical ball,
a valve seat having a through-hole provided with a truncated side surface-shaped inner surface, and
a compression coil spring provided inside the cylinder chamber, having a first end portion in contact with the ball and a second end portion in contact with the cylinder, with a value of a winding diameter reduced at the first end portion, and
when the fuel is introduced into the cylinder chamber, the compression coil spring is compressed so as to open the through-hole in the valve seat and to allow passage of the fuel therethrough.

2. The diesel fuel pump according to claim 1, wherein a portion of the compression coil spring to receive the ball has a reduced winding radius.

3. The diesel fuel pump according to claim 1, wherein
the cylinder includes a through-hole where the plunger enters,
the through-hole includes
a first region provided at a third end portion,
a second region provided at a fourth end portion, and
a third region formed between the first region and the second region,
the compression coil spring enters and comes into engagement with the first region,
an inside diameter of the second region is made smaller than an inside diameter of the first region,
the plunger is in engagement with the second region for the reciprocating motion, and
an inside diameter of the third region is made smaller than the inside diameter of the first region and slightly larger than the inside diameter of the second region.

4. The diesel fuel pump according to claim 3, wherein
a step is formed on an outer periphery of the cylinder, and an outside diameter of a region closer to the third end portion than the step is made larger than an outside diameter of a region close to the fourth end portion than the step,
the cylinder is installed in the housing by bringing the region closer to the third end portion than the step into engagement with the housing, and
a boundary between the second region and the third region is provided closer to the drive shaft than the step in light of an extending direction of a center axis of the cylinder.
